(19) United States
(12) Patent Application Publication
(10) Pub. No.: US 2008/0128213 A1
(43) Pub. Date: Jun. 5, 2008

(54) COMBINATION ELECTRICAL AND BATTERY-POWERED CONTROL SYSTEM FOR STAIRWAY CHAIRLIFT

(76) Inventor: Timothy R. Harris, Overland Park, KS (US)

Correspondence Address: HUSCH BLACKWELL SANDERS LLP, 4801 Main Street, Suite 1000, KANSAS CITY, MO, 64112, US

(21) Appl. No.: 11/564,947

(22) Filed: Nov. 30, 2006

(51) Int. Cl. B66B 9/08; B66B 1/06; H02J 9/00

(52) U.S. Cl. 187/201; 187/289; 187/290

(57) ABSTRACT

The present invention is directed to a stairway chairlift system that includes a rail assembly mounted adjacent a wall along a stairway and further includes a motorized chair unit movable along rail assembly in ascending and descending directions along stairway. More particularly, the stairway chairlift system is normally powered from an Electric power supply 108. However, during AC power failure, the chair lift system automatically switches to battery power to enable chairlift 10 to run a number of trips after a power failure. After the power outage ends, the chairlift system automatically switches back to AC power supply for lift operations and the batteries are then recharged. Thus, if AC power is available, the batteries are not used or drained. Furthermore, the batteries are not continually charged and discharged as they are in a DC battery-operated system.

### BACKGROUND OF THE INVENTION

This invention relates generally to lift mechanisms and, more particularly, to a combination electrical and battery-powered control system for controlling the operation of a stairway chairlift operable to transport people, including those that may be disabled, in ascending and descending directions along a stairway.

Over the years, a variety of mechanisms have been developed for increasing the mobility of people, such as those confined to wheelchairs, who have difficulty climbing up and down stairs. One of the most successful of the mechanisms has been the stairway chairlift that, in its most common form, comprises a rigid metal rail, mounted along a stairway, and a motorized chair unit adapted to ride along the rail. Typically, the rail is positioned adjacent a wall along the stairway, and the chair unit includes a passenger seat at its upper end on which the passenger sits. To avoid interference with ordinary use of the stairway, stairway chairlifts are preferably arranged to project outwardly from the stairway walls as little as possible.

To increase the ease with which a passenger of often-times limited mobility can operate the stairway chairlift, the unit is typically motorized. Known motorized chairlifts are typically powered by AC power. However, in the event of an electrical outage such as during bad weather events, the chairlift is not operational and the passenger is unable to ascend or descend stairways. Alternatively, some available chairlifts are powered by a battery operating system. However, chairlift operating systems that run solely off of a battery must be parked on a charging station to keep the batteries charged. This can be a time-consuming and inconvenient hassle for the passenger. Thus, there is a need in the art for a stairway chairlift operating system that is generally powered by AC power but, in the event of an electrical outage, can switch to a battery-powered operating system to enable the passenger to maintain mobility up and down stairways.

### SUMMARY OF THE INVENTION

The present invention is directed to a stairway chairlift system that includes a rail assembly mounted adjacent a wall along a stairway and further includes a motorized chair unit movable along rail assembly in ascending and descending directions along stairway. The stairway chairlift system of the present invention is normally powered from an AC power source. However, during AC power failure, the chair lift system automatically switches to battery power to enable chairlift 10 to run a number of trips after a power failure. After the power outage ends, the chairlift system automatically switches back to the AC power supply for lift operations and the batteries are then recharged. Thus, if AC power is available, the batteries are not used or drained. Furthermore, the batteries are not continually charged and discharged as they are in a DC battery-operated system.

### BRIEF DESCRIPTION OF THE SEVERAL VIEWS OF THE DRAWING

In the accompanying drawings that form a part of the specification and that are to be read in conjunction therewith and in which like reference numerals are used to indicate like parts in the various views:

FIG. 1 is a front perspective view of the stairway chairlift system in accordance with one embodiment of the present invention;

FIG. 2 is a front perspective view of the chassis mounted on the rail assembly with a portion of the rail assembly in cross-section in accordance with one embodiment of the present invention;

FIG. 3 is a cross-section of the chassis mounted on the rail assembly of FIG. 2 along line 3-3 in accordance with one embodiment of the present invention;

FIG. 4 is a bottom perspective view of a chassis mounted on a gear rack in accordance with one embodiment of the present invention;

FIG. 5 is a bottom elevational view of a chassis mounted on a gear rack in accordance with one embodiment of the present invention;

FIG. 6 is a side perspective view of a chassis mounted on a gear rack in accordance with one embodiment of the present invention;

FIG. 7 is a front perspective view of an end cap in accordance with one embodiment of the present invention;

FIG. 8 is a cross-section of a rail assembly in accordance with one embodiment of the present invention;

FIG. 9 is a cross-section of a chassis mounted on a rail assembly in accordance with one embodiment of the present invention; and

FIG. 10 is a schematic depicting operation of a power supply in accordance with one embodiment of the present invention.

### DETAILED DESCRIPTION OF THE INVENTION

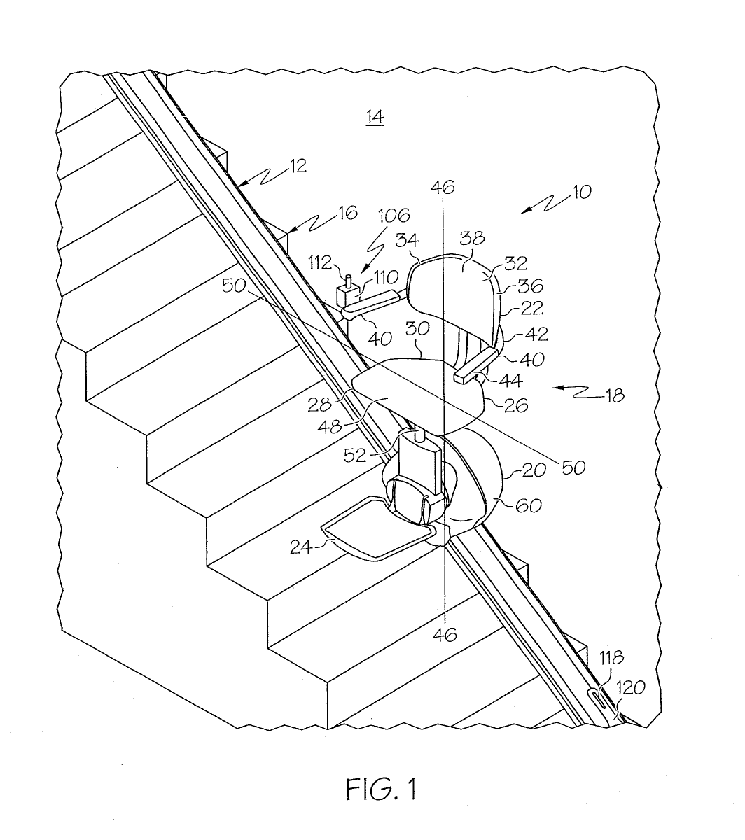

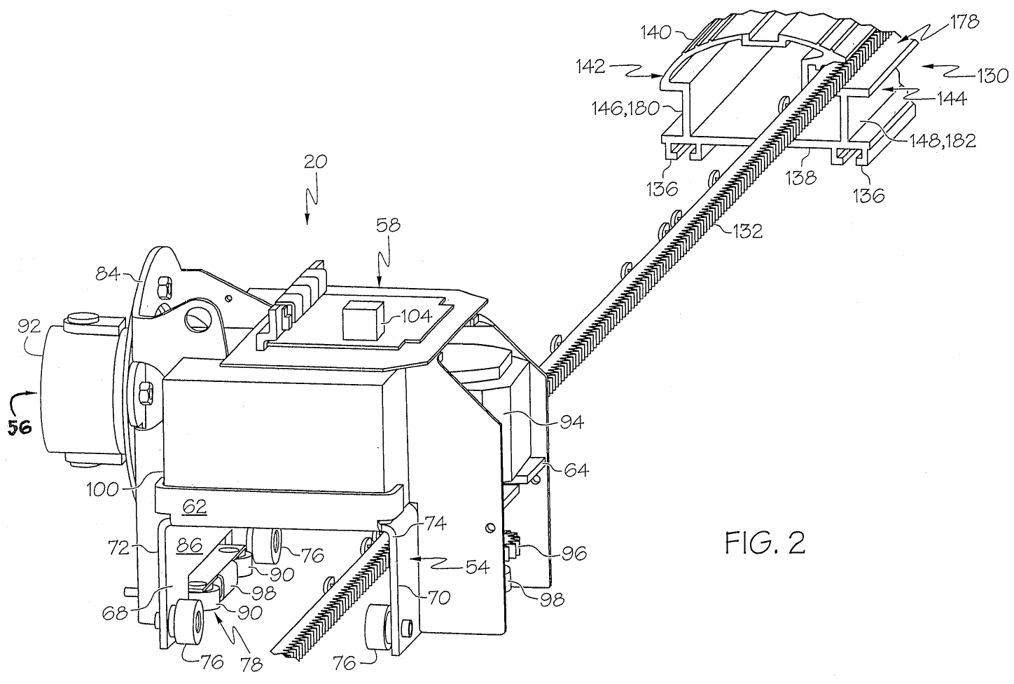

A stairway chairlift system 10 embodying various features of the invention is shown in the drawings. As shown in FIGS. 1 and 2, chairlift system 10 includes a rail assembly 12 mounted adjacent a wall 14 along a stairway 16 and further includes a motorized chair unit 18 movable along rail assembly 12 in ascending and descending directions along stairway 16.

Motorized chair unit 18 includes a chassis 20 and a passenger seat portion 22. Passenger seat 22 is mounted proximate the top of chassis 20 and a generally planar foot rest 24, for supporting a passenger's feet during transport along stairway 16, is mounted adjacent the lowermost end of chassis 20. Passenger seat 22 includes a substantially horizontal portion 26 having a forward edge 28 and a rearward edge 30, and further includes a generally vertical back portion or seat-back 32 extending upwardly from rearward edge 30 of horizontal portion 26. In one embodiment, seat-back 32 is curved so that vertical side edges 34 and 36 of seat-back 32 are spaced farther from wall 14 than is a center portion 38 of seat-back 32 when passenger seat 22 is in the position illustrated in FIG. 1.

Passenger seat 22 may include an internal frame assembly (not shown) that is formed of rigid structural members, such as steel tubing and channels, and further includes an exterior sheath formed of molded plastic or similar resilient, decorative material, overlying the rigid internal framework so as to contour and pad passenger seat 22 for maximum passenger comfort. Passenger seat 22 includes a pair of arms 40 and 42 extending horizontally forwardly from back portion 32 of seat 22 over, and substantially parallel to, horizontal portion 26 of seat 22. In accordance with one aspect of the invention, arms 40 and 42 may curve inwardly toward each other so as to form a passenger restraining barrier around and above horizontal portion 26 of seat 22. In addition, each of arms 40 and 42 includes a first or rearward portion 44 adapted to be pivotally connected, at one end, to side edge 34 or 36 of seat-back 32, and a second or forward portion 46 extending from the remaining end of rearward portion 46 and supported for pivotal movement substantially around a longitudinal or vertical axis 46 of rearward portion 44. This permits forward portion 44 of each arm 40 or 42 to be rotated so as to lie in a substantially horizontal plane or in a substantially vertical plane. In addition, each of arms 40 and 42 can be pivoted relative to seat-back 32 so as to lie in a substantially horizontal position or a substantially vertical position.

To minimize interference with ordinary use of stairway 16 when stairway chairlift 10 is standing idle, motorized chair unit 18 can be folded so as to reduce the overall extent by which chair unit 18 extends outwardly from wall 14 and into the path of stairway 16. In particular, passenger seat arms 40 and 42 can be folded to an upright position and horizontal portion 26 of passenger seat 22 includes a forward section 48 that is mounted for pivoting movement around a generally horizontal axis 50 extending across the width of seat 22 for pivoting movement between a lowered, horizontal position and a raised, substantially vertical position. In addition, foot rest 24 is mounted to chassis 20 of chair unit 18 for pivoting movement between a lowered, horizontal position and a raised, substantially vertical position. When folded, the overall thickness and, thus, the extent to which chair unit 18 extends into stairway 16 is substantially the thickness of chassis 20.

To further the ease with which an oftentimes disabled person can move into or out of passenger seat 22, chair unit 18, in accordance with one feature of this invention, includes a swivel mechanism (not shown) having a pivot or chair shaft 52 that permits passenger seat 22 to pivot around substantially vertical axis 46 from a first position, wherein rear edge 30 of seat 22 is substantially parallel to stairway wall 14, to a second position wherein rear edge 30 of seat 22 is transverse to wall 14. Preferably, the seat swivel mechanism allows seat 22 to be rotated through substantially 180° of arc from the second position, wherein rear edge 30 of seat 22 is substantially perpendicular to wall 14, through the first position, wherein rear edge 30 of seat 22 is substantially parallel to stairway wall 14, to a third position wherein rear edge 30 of seat 22 is once again substantially perpendicular to stairway wall 14. It will be appreciated by one skilled in the art that the swivel seat mechanism may further include means for locking passenger seat 22 in any one of the first, second, or third positions. In addition, it will be appreciated that means can be provided for locking the passenger seat in positions between the first, second and third positions.

In order to minimize the extent to which passenger seat 22 extends outwardly from stairway wall 14 and still provide rotation of seat 22 between the first, second and third positions, the seat swivel mechanism is arranged so as to provide a substantially constant minimum clearance between 22 seat and stairway wall 14 as seat 22 rotates between the first, second and third positions. To this end, the seat swivel mechanism is arranged so that, as seat 22 moves from the first, or center position, wherein the rear edge 30 of seat 22 is substantially parallel to stairway wall 14, toward either of the second or third positions, substantially vertical axis 46, around which seat 22 rotates, moves laterally outwardly from stairway wall 14. As seat 22 is rotated from either of the second or third positions back toward the center or first position, the vertical axis 46 around which seat 22 rotates moves laterally inwardly toward wall 14. By maintaining a substantially constant minimum clearance between seat 22 and stairway wall 14 as the seat rotates, rail assembly 12 can be mounted closer to wall 14.

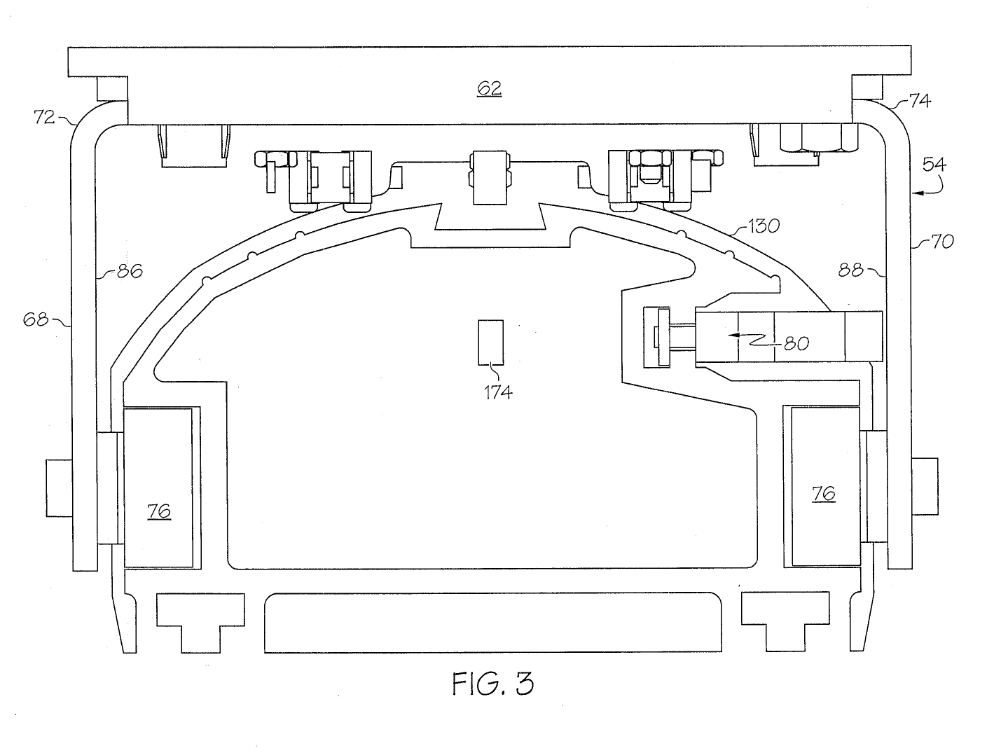

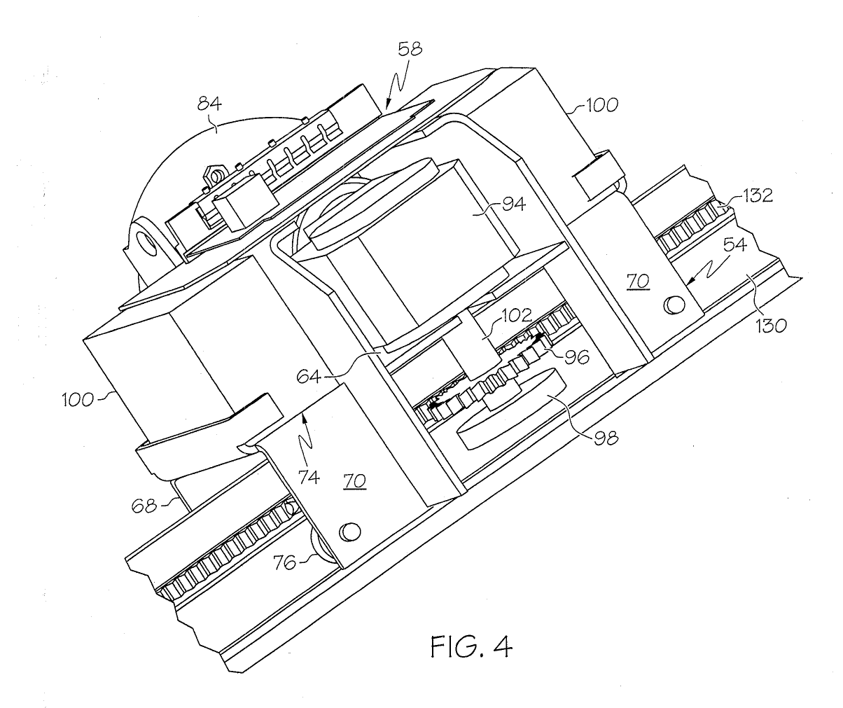

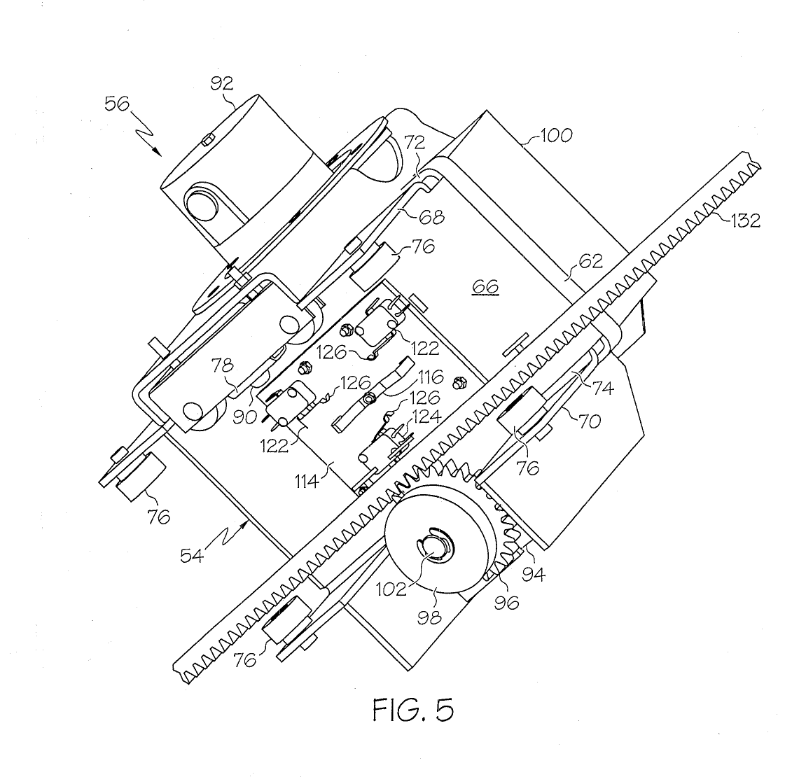

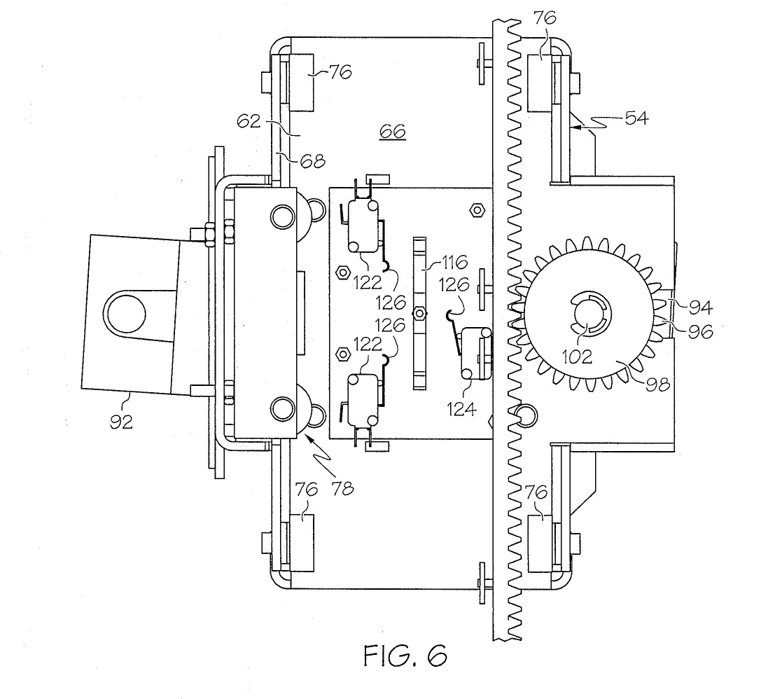

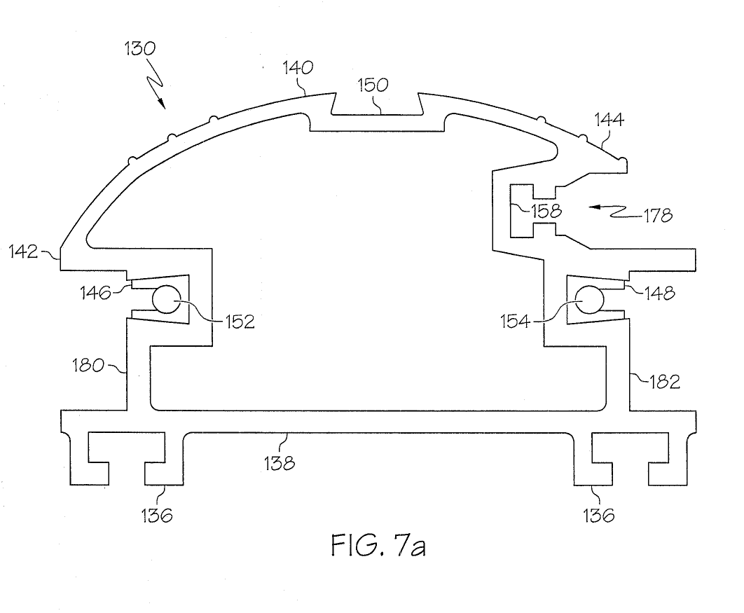

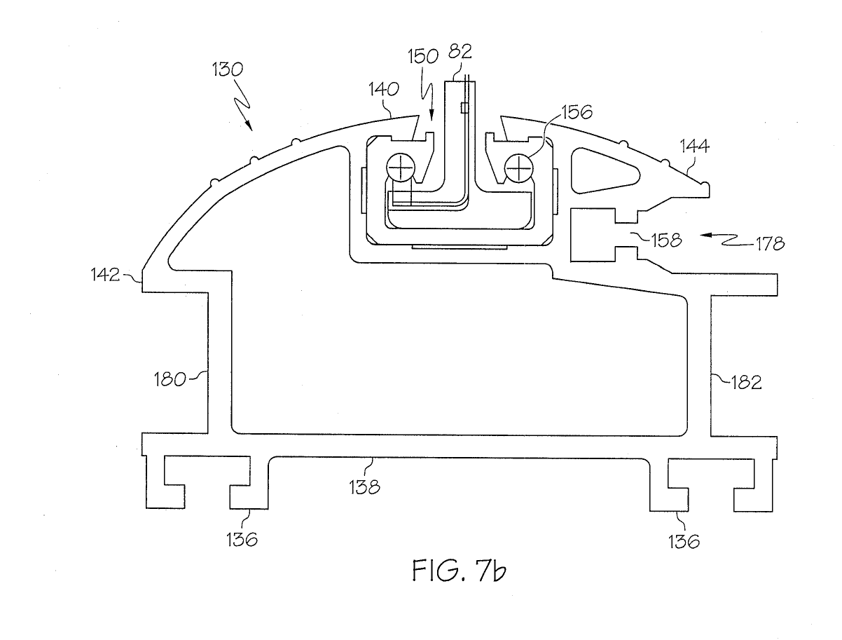

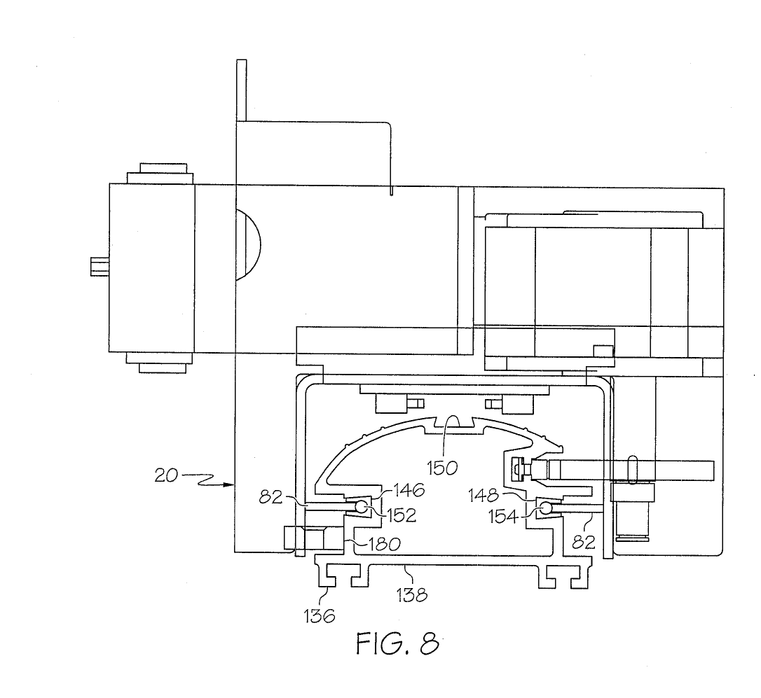

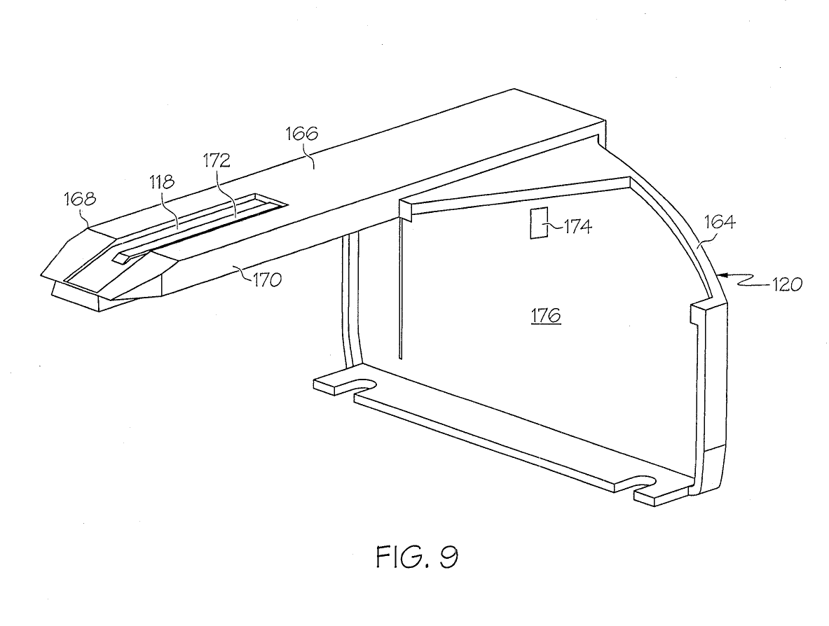

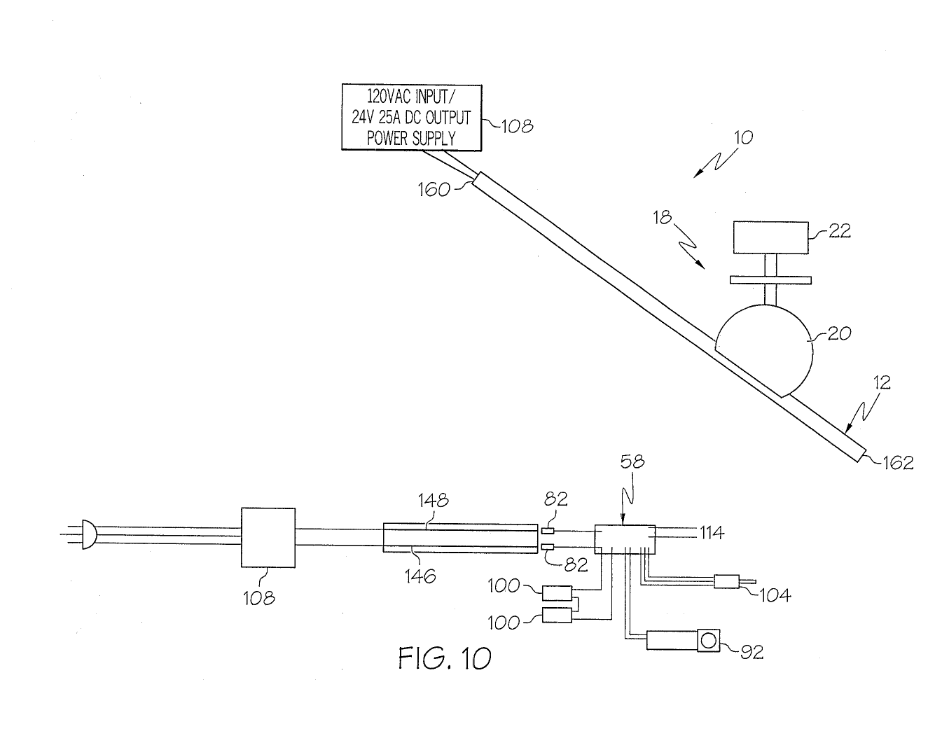

Turning to FIGS. 2 and 3, chassis 20 includes a frame 54, a motor drive unit 56, a control system 58, and a housing 60. Frame 54 is configured to receive rail assembly 12 therethrough and includes a substantially horizontal portion 62 having an upper surface 64 and a lower surface 66. First and second planar legs 68, 70 extend downwardly from a first and second edge 72, 74 of horizontal portion 62. Legs 68, 70 may be continuous or sectioned to accommodate other mechanisms. For example, leg 70 may have two sections disposed on either side of gearing. Frame 54 further includes at least two, and preferably four, load wheels 76, a take-up weldment assembly 78, a T-shaped gear rack mounting assembly 80, at least one electrical brush assembly 82, and a chair mount assembly 84. Load wheels 76 are mounted to inner surfaces 86 and 88 of legs 68 and 70 for rolling engagement with rail assembly 12. Take-up weldment assembly 78 extends inwardly from inner surface 86 of leg 68 and includes one or more spring-loaded members 90 for contacting rail assembly 12 in order to maintain the pitch as chair unit 18 ascends and descends rail assembly 12. One or more generally T-shaped gear rack mounting assemblies 80 extend inwardly from inner surface 88 of leg 70 to facilitate mounting of chair unit 18 onto rail assembly 12. One or more electrical brush assemblies 82 configured to electrically contact rail assembly for powering motor drive unit 56 extend inwardly from inner surface 86 and/or 88 of legs 68 and 70 and/or surface 66 and are held under spring tension. Electrical brush assembly 82 may be any type of motor brush known in the art. Particularly preferred are graphite brushes. Chair mount assembly 84 may be provided adjacent first edge 72 of frame 54 for receiving chair shaft 52.

Motor drive unit 56 includes a motor 92, a gear box 94, a pinion 96, a gear set wheel 98, and at least one battery, but preferably two, batteries 100. Motor 92 is preferably supported by or mounted externally to frame 54 and may extend through housing 62. As known in the art, motor 92 is operably coupled to appropriate gear linkage (not shown) including a first shaft (not shown) proximate a first end and gear box 94 is operably coupled to appropriate gear linkage (not shown) including first shaft proximate a second end. Appropriate gear linkage including a second shaft 102 operably connects gear box 94 to pinion 96 and gear set wheel 98.

Control system 58 includes a control module 104 preferably supported by or mounted externally to frame 54. Control module 104 coordinates and governs operation of chair unit 18. Control module 104 provides circuitry in the form of a compact module with a protective housing, and further operates in a so-called “dual mode” fashion so that control module 104 may communicate with an input device 106 (e.g., by receiving input signals from the device) as well as supply electrical power thereto. In this way, neither electric power supply 108 (described hereinbelow) nor batteries 100 have to supply electrical power directly to input device 106, but only through control module 104 to input device 106 when it is needed. This arrangement reduces the amount of power cabling needed in control system 58, as such cabling does not have to be extended to input device 106. Alternatively, control module 104 and input device 106 may be in the form of a single integrated controller residing in a single housing and receiving power directly from batteries 100 or power supply 164.

Control system 58 is configured to operate on electric power supply 108 and/or batteries 100. Electric power supply 108 is operably coupled to rail assembly 12 for powering motor 92 as described in more detail hereinbelow. Power supply 164 preferably includes a 120V AC input and a 24V DC output. Batteries 100 are preferably housed atop upper surface 64 of frame horizontal portion 62 on either side of first gear shaft (not shown). In another embodiment, batteries 100 may be disposed independently of chassis 20 and directly operatively connected to electric power supply 108. Control system 58 is preferably configured to operate on 24 volt DC power such that batteries 100 are preferably each a deep cycle 12 volt DC type battery. However, as used herein, the term “battery” or “batteries” is a device for generating electric current by chemical reaction and, in addition to the DC type battery discussed above, may also include lithium-ion batteries, fuel cells, or any available power source generated by chemical reaction. Additionally, circuit breakers may be provided with batteries 100 when excessive current is being drawn by the components of control system 54 and/or motor drive unit 56.

Control module 104 also includes, in one embodiment, a processor (e.g., microprocessor, microcontroller or application-specific integrated circuit) for receiving inputs from input device 106 or other devices (e.g., a speed sensor measuring the rate of rotation of gear set wheel 98 and pinion) and managing the amount of electrical power supplied through outputs to motor 92, and a memory device for storing program code or other data. By controlling the supply of electrical power in accordance with operator input received on input device 106, and optionally, with sensed rotational speed of gear set wheel 98, control module 104 regulates the amount of power output of motor drive unit 56. Similarly, based on the operator input received on input device 106 (i.e., up or down direction of travel), control module 104 determines the direction of current flow supplied to motor drive unit 56 to cause gear set wheel 98 and pinion rotation in a desired direction. For instance, if a measured speed of rotation of gear set wheel 98 and pinion is less than a speed of travel for chairlift 10 selected on input device 106, such as when chairlift 10 encounters resistance from gravity when traveling in an upward direction, control module 104 will draw more current from power supply or batteries 100 to motor drive unit 56 to produce more motive power.

Input device 106 is configured to generate a signal based on the input received from an operator and transmit the signal to control module 104 to control motor drive unit 56 operation. Preferably, input device 106 includes a housing 110, a joystick lever 112 mounted with housing 110 for accepting operator inputs regarding a direction of travel, an optional rotatable speed control knob (not shown) mounted with housing 110 for selecting a speed of travel, and circuitry (not shown) to process the input received through lever 112 and knob and generate a command signal for transmission to control module 104. Joystick lever 112 may be positioned in a generally vertical orientation when in a neutral position but may also be positioned in various neutral position orientations by moving control module 104 to other orientations. For example, joystick lever 112 may be generally horizontal in neutral. In another embodiment, push button controls or the like may be used as input device 106 instead of a joystick lever 112. The circuitry for input device 106 may include a processor and memory device similar to that of control module 104. Also, input device 106 is preferably mounted on one of arms 40 or may be mounted directly to passenger seat horizontal portion 26. This allows joystick lever 112 and other input capturing means on device 302 to be easily reached by the operator guiding the movement of chairlift 10 without completely removing his/her hand from arms 40. Input device 106 may be programmed to customize how certain movements of joystick lever 112 will generate command signals for transmission to control module 104 regulating current flow to motor drive unit 56.

Control system 58 also includes a switch board 114 disposed on lower surface 66 of frame horizontal portion 62. Switch board 114 includes a charging strip 116 for charging batteries 100 when operably coupled to a complementary charging strip 118 on each one of a pair of end caps 120. In another embodiment, switch board 114 includes charging circuitry for charging batteries 100 directly. Switch board 114 also includes at least one current reversing device, such as one or more relays or limit switches, to control the direction of current flow supplied to motor drive unit 56. In a preferred embodiment, at least two primary limit switches 122 and at least one final limit switch 124 are operably connected to switch board 114. Each of switches 122 and 124 includes at least one actuator lever 126. Switch board 114 provides circuitry (not shown) that communicates with control module 104 in order to generate command signals to control module 104 regulating current flow to motor drive unit 56.

Rail assembly 12 includes a substantially rigid guide rail 130 extending along wall 14 of stairway 16, a length of teeth or gear rack 110 coupled to guide rail 130 along the length of guide rail 130, and a pair of end caps 120 disposed at opposing ends of guide rail 130. The rigid tubing forming guide rail 130 may be shaped so as to conform generally to the course of stairway 16. Guide rail 130 is supported above, and generally parallel to, stairway 16 by a plurality of brackets or clamps 136 or other mounting apparatus running substantially along bottom surface 138 of the entire length of guide rail 130. Alternatively, guide rail 130 can be supported on a plurality of supports extending outwardly from wall 14 along stairway 16. In another embodiment, guide rail 130 can be supported by means of a plurality of stanchions projecting upwardly from stairway 16. In addition to bottom surface 138, guide rail 130 includes a top surface 140, a first side 142, and a second side 144. A first channel 146 is provided in first side 142 such that first channel 146 runs generally along the entire length of guide rail 130 and is configured to receive a first brush assembly 82. In a second embodiment, a second channel 148 is preferably provided in second side 144 such that second channel 148 runs generally along the entire length of guide rail 130 and is disposed substantially parallel to first channel 146. Second channel 148 is configured to receive a second brush assembly 82. In a third embodiment, top surface 140 includes a third channel 150 that runs generally along the entire length of guide rail 130. First channel 146 includes a first electrical contact member 152 such as a direct current (DC) power strip, conduit, rail or the like, disposed or embedded therein for electrical connection with first brush assembly 82. In a second embodiment, second channel 148 also includes a second electrical contact member 154 such as a DC power strip, rail, conduit, or the like, disposed or embedded therein for electrical connection with second brush assembly 82. In a third embodiment, third channel 150 also includes a third electrical contact member 156 such as a DC power strip, rail, conduit, or the like, disposed or embedded therein for electrical connection with a third brush assembly 82. It will be appreciated by one skilled in the art that any combination of the above channels and electrical contact members may also be made. For example, all three channels 146, 148, 150 may be present in guide rail 130, first and second channels 146, 148 may only be present, second and third channels 148, 150 may only be present, first and third channels 146, 150 may only be present, and an electrical contact member 152, 154, 156 may be provided in one, two, or three of channels 146, 148, 150. In one embodiment, charging strip 116 may electrically contact one or more of electrical contact members 152, 154, 156, for charging of batteries 100. A fourth channel 158 may also be provided in first or second side 142, 144 such that fourth channel 158 runs generally along the entire length of guide rail 130 and is configured to receive T-shaped mounting assembly 80.

Generally L-shaped first and second end caps 120 are also provided wherein first end cap 120 is disposed on a first end 160 of guide rail 130 and second end cap 120 is disposed on an opposing second end 162 of guide rail 130. First and second end caps 120 provide means for charging batteries 100 in chassis 20 and may also act as a stop means for chassis 20. First and second end caps 120 include a first portion 164 configured to be received or coupled to first or second end 160, 162 of guide rail 130. First and second end caps 120 further include an elongated second portion 166 configured to be received within third channel 150. Second portion 166 includes a first side 168 and a second side 170 configured to electrically contact primary and final limit switches 122 and 124 mounted on chassis 20. Second portion 166 also includes charging strip 118 having a first exposed portion 172 configured to electrically engage charging strip 116 mounted on chassis 20. In another embodiment, second portion 166 includes charging circuitry for directly charging batteries 100 without the need for charging strip 116. A nonexposed portion of charging strip 118 extends through elongated second portion 166 and into first portion 164 such that an opposing end 174 of charging strip 118 is exposed and extends through a first surface 176 of first portion 164. Exposed opposing end 174 is configured to electrically contact a charging harness (not shown) and accessing charging electronics within chassis 20. Finally, a fifth channel 178 running generally along the entire length of guide rail 130 is provided and configured to receive gear rack 132 for matingly engaging pinion 96 mounted on chassis 20. First side 142 also includes a first load wheel channel 180 and second side 144 includes a second load wheel channel 182. First and second load wheel channels 180, 182 are configured to receive and guide load wheels 76 therein along the length of guide rail 130.

In use, after rail assembly 12 is affixed to stairway 14, chair unit 18 is mounted onto rail assembly 12 by slidably inserting T-shaped chair mount assembly 80 into fourth channel 158 such that one or more brush assemblies 82 are in electrical communication with one or more electrical contact members 152, 154, 156. Electric power supply 108 is switched on thereby providing electric power to electrical contact members 152, 154, 156. After boarding chair unit 18, a passenger uses input device 106 to communicate direction of travel to control system 58 and engages motor drive unit 56. Motor 92 communicates via the gear linkage to pinion 96 that matingly engages gear rack 118 and moves chair unit 18 in the desired direction of travel. Upon reaching one end of rail assembly 12, charging actuator lever 126 of one of primary limit switches 122 contacts sides 168 and 170 of end cap 120. Primary limit switch 122 communicates with control module 104 and transmits a command to control module 104 to stop chair unit 18. As a failsafe, if primary limit switch 122 fails to transmit, charging actuator lever 126 of final limit switch 124 will contact sides 168 and 170 of end cap 120 and transmit a command to control module 104 to stop chair unit 18. Chairlift 10 normally operates from electric power supply 108 that also maintains batteries 100 in a charged condition by complementary engagement of charging strip 116 to charging strip 118 when chair unit 18 is stopped at an end cap 120 at one end 160 or 162 of rail assembly 12. During AC power failure, control module 104 automatically switches to batteries 100 for power to enable chairlift 10 to run a number of trips after a power failure. After the power outage ends, control module 104 automatically switches back to power supply 108 for lift operations and batteries 100 are recharged. Thus, if AC power is available, batteries 100 are not used or drained. Furthermore, batteries 100 are not continually charged and discharged as they are in a DC battery-operated system. It is also within the scope of this invention to provide for manual switching from power supply 108 to batteries 100 and vice versa.

From the foregoing, it may be seen that the chairlift system of the present invention displaying automatic conversion from AC power to DC power is particularly well suited for the proposed usages thereof. Furthermore, since certain changes may be made in the above invention without departing from the scope hereof, it is intended that all matter contained in the above description or shown in the accompanying drawing be interpreted as illustrative and not in a limiting sense. It is also to be understood that the following claims are to cover certain generic and specific features described herein.

We claim:

1. A control apparatus for controlling the operation of a motorized chairlift movable along a wall of a stairway, said control apparatus comprising:
a power supply;
a battery; and
a controller;
wherein said controller is operatively connected to said battery and said power supply for switchable engagement thereof.

2. The control apparatus of claim 1, said controller comprising a control module and a switch board.

3. The control apparatus of claim 2, said control module being operatively connected to a motor and configured for regulating current flow from said power supply or said battery to said motor.

4. The control apparatus of claim 3 further comprising an operator input device for transmitting operation signals to control module.

5. The control apparatus of claim 2, said switch board being operatively connected to said control module and comprising at least one charging mechanism for charging said battery and at least one limit switch for transmitting a stop command to said control module.

6. The control apparatus of claim 1, said chairlift comprising a passenger seat coupled to a chassis configured for movement along a rail assembly.

7. The control apparatus of claim 6, said passenger seat comprising a swivel mechanism for pivoting said seat around a substantially vertical axis.

8. The control apparatus of claim 6, at least a portion of said passenger seat comprising a pivot mechanism for pivoting movement between a lowered, substantially horizontal position and a raised, substantially vertical position.

9. The control apparatus of claim 6, said chassis comprising at least one electric brush assembly and said rail assembly comprising at least one electrical contact member operatively connected to said power supply wherein said brush assembly is in electrical contact with said electrical contact member for movement of said chairlift along said rail assembly.

10. The control apparatus of claim 9, said rail assembly further comprising an end cap disposed on each end of said rail assembly wherein said end caps comprise at least one charging mechanism for charging said battery.

11. The control apparatus of claim 1 wherein said controller automatically engages said battery in response to a substantial absence of power from said power supply.

12. The control apparatus of claim 11 wherein said controller automatically engages said power supply in response to substantially available power from said power supply.

13. A control system for providing substantially continuous power for operation of a motorized chairlift movable along a stairway, said control system comprising:
a first power means for providing direct electrical current;
a second power means for providing direct electrical current; and
a control means for switchablyly engaging said first and second power means.

14. The control system of claim 13, said first power means comprising an electrical power supply.

15. The control system of claim 13, said second power means comprising a battery.

16. The control system of claim 13, wherein said control means automatically engages said second power means in response to a substantial absence of power from said first power means.

17. The control system of claim 13, wherein said control means automatically engages said first power means in response to substantially available power from said first power means.

18. The control system of claim 13, said control means being operatively connected to a motor and configured for regulating current flow from said first or second power means to said motor.

19. The control system of claim 13, said control means further comprising charging means for charging said second power means.

20. A control apparatus for providing substantially continuous power for operation of a motorized chairlift moveable along a stairway, said control apparatus comprising:
a primary power supply;
an alternate power supply;
a power monitor operatively connected to said primary power supply and said alternate power supply; and
a controller operatively connected to said monitor, said primary power supply, and said alternate power supply for switchable engagement of said primary power supply and said alternate power supply.
